(19) United States
(12) Patent Application Publication
(10) Pub. No.: US 2003/0097426 A1
(43) Pub. Date: May 22, 2003

(54) Imaging device configuration and upgrade

(76) Inventor: Travis J. Parry, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/990,005

(22) Filed: Nov. 21, 2001

(51) Int. Cl. G06F 15/177; G06F 15/16

(52) U.S. Cl. 709/220; 709/229; 709/218

(57) ABSTRACT

An improved class of imaging devices with an ability to communicate, accept commands, change configuration parameters, and upgrade firmware/software via an embedded webserver are described. The improved imaging devices with an embedded webserver, allow the imaging devices to be managed, configured, and upgraded from a web browser via hypertext transfer protocol (HTTP). This presents a simple interface and protocol that has the added benefit of being available in most network environments and having browsers on many host platforms. Additionally, the improved imaging devices are adapted to find and/or upgrade other imaging devices on the network.

### TECHNICAL FIELD OF THE INVENTION

The present invention relates generally to imaging device communication and in particular the present invention relates to imaging device communication and management via HTTP.

### BACKGROUND OF THE INVENTION

Computing devices are typically coupled to networks in modern computing environments. Networks in this definition include fiber optic, wire, wireless, and virtual, such as a virtual private network (VPN). In particular, imaging devices, such as printers, projectors, displays, and faxes are typically networked in modern computing environments. These imaging devices are typically set up and configured with a built-in user interface or are configured remotely over the network. Imaging devices in organizations are typically implemented as networked imaging service providers in computer networks.

When being configured over the network, the imaging devices generally require a specialized management facility, program, or protocol to interface with. These specialized management facilities, programs, or protocols are generally referred to herein as management facilities. The management facilities are typically specific to the device, class of device, or even device manufacturer, that is being managed or communicated to. This narrowness of use with existing management facilities can cause issues with ease of management of the imaging devices. In addition, in many situations, network features such as firewalls or routers interfere with the management facilities being utilized. The result being that some or all of the imaging devices being managed are unreachable across the network with the management facility.

In addition, the management facilities often differ in interface and function and thus require the user/administrator to remember the particulars of configuring the management facilities and operating the management facilities. Oftentimes this requires the user/administrator to have training in the operation of the particular management facility used by the imaging device being managed. The management facilities are also often updated or changed as new features and capabilities are introduced to the devices and/or the management facilities themselves. Thus, with multiple management facilities, managing and communicating with these imaging devices is difficult, time consuming, and inconvenient for the network administrator and users.

Many imaging devices gather usage information and statistics on their use and operation within the network, in addition to allowing for online changing of configuration parameters and upgrades of firmware or software (generally referred to herein as configuration). This usage information, statistics, along with the configuration and upgrade options are generally available to the administrator through the management facility. Some of the commonly used settings and gathered usage information includes job origin, number of pages printed or imaged, resolution, mode, duplex, economy and performance settings, number of copies of jobs received, number of errors, types of errors, toner usage, toner level, paper type and usage, and other usage information, statistics, or consumables. However, many other types of settings, usage information, and statistics can are available in imaging systems.

Many of these imaging devices are also configured with options specific to the device, its location, or its purpose. Imaging devices on a network can and typically are of many device types, brands, and models. However, organizational and network-wide common device configurations, where a baseline configuration is established across all devices or a class of devices, are a standard practice. This is particularly true among imaging devices of a similar type, model, or manufacturer.

FIG. 1 details a simplified diagram of a network and imaging device system. FIG. 1 includes a local network 100, a router/bridge 102, firewalls 104, a remote network 106, local imaging devices 108, a server 112, a workstation 114, a management facility 116, and a remote imaging device 118. Each local and remote imaging device 108, 118 is coupled to the network with a network interface, contains device configuration information and firmware/software, and gathers it own usage information and statistics, which can include such information as number of pages imaged, number of jobs received, number of copies of jobs received, and numbers of errors. Each imaging device generally includes a processor 103 and a computer-usable media 105 as shown in one of the imaging devices 108. The computer-usable media 105 may include one or more types of media, e.g., nonvolatile memory, magnetic media, optical media, etc., for storage of computer-readable instructions for use by the processor 103 to control operations of the imaging device 108 and for storage of usage data, statistics and other data or information used by the imaging device 108. The processor 103 is adapted for communication across the network 100, typically through a network interface such as a network interface card. The processor 103 may be coupled to the computer-usable media 105 as separate components or the processor 103 and the computer-usable media 105 may be coupled together as part of a single component, such as an application-specific integrated circuit (ASIC) chip.

The management facility 116 allows management and querying of the local and remote imaging devices 108, 118 across the network. Each local imaging device 108 communicates to the management facility 116 across the local network 100, and router-bridge 102, if necessary. Each remote imaging device 118 communicates to the management facility 116 across the remote network 106, firewalls 104, and local network 100.

For the reasons stated above, and for other reasons stated below which will become apparent to those skilled in the art upon reading and understanding the present specification, there is a need in the art for a method of conveniently communicating to and managing imaging devices in a network environment.

### SUMMARY OF THE INVENTION

The above-mentioned problems with organizing, communicating with, and managing imaging devices that have multiple management facilities are addressed by the present invention and will be understood by reading and studying the following specification.

In one embodiment, an imaging device system comprises a network, and a. plurality of imaging devices that are each coupled to the network with a network interface, wherein one or more imaging devices of the plurality of imaging devices contains an embedded webserver coupled to the network interface, where the embedded webserver is adapted to allow configuration of the imaging device.

In a method of operating a plurality of imaging devices of an imaging device system, the method comprises communicating a configuration change to an embedded webserver of at least one imaging device of the imaging device system, and processing the configuration change on the at least one imaging device of the imaging device system.

In another embodiment, a computer-usable medium has computer readable instructions stored thereon for execution by a processor to perform a method. The method comprises communicating a configuration change at an embedded webserver of an imaging device, and processing the configuration change on the imaging device.

### BRIEF DESCRIPTION OF THE DRAWINGS

FIG. 1 is a simplified diagram of a typical imaging device system.

FIG. 2 is a simplified diagram of an imaging device system in accordance with an embodiment of the present invention.

FIGS. 3A and 3B are simplified diagrams showing communication of files to and from an imaging device embodiment of the present invention.

FIG. 4 is a simplified diagram showing upgrading and management of several imaging device embodiments of the present invention.

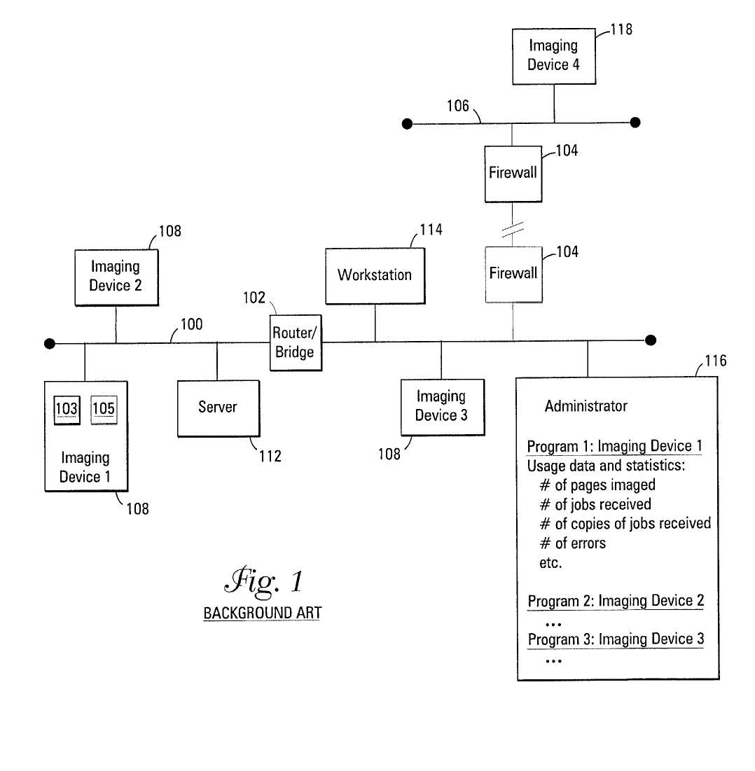

### DETAILED DESCRIPTION OF THE INVENTION

In the following detailed description of the preferred embodiments, reference is made to the accompanying drawings that form a part hereof, and in which is shown by way of illustration specific preferred embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims.

Embodiments of the present invention include imaging devices that have embedded webservers that utilize hypertext transfer protocol (HTTP) to communicate with the coupled network. This allows these imaging devices to be configured over a network with a common non-device specific interface and protocol, without requiring a special purpose management facility. For purposes of this disclosure, networked imaging devices include, but are not limited to, printers, multi-function copiers, faxes, digital cameras, digital projectors, terminals, and other such imaging devices. An embedded webserver is a function of the imaging device's processor in response to instructions stored on a computer-usable media.

With a common webserver (HTTP) interface and protocol, the need for training, support, and configuration of multiple specialized management facilities is simplified as each imaging device of the present invention already contain a management facility in the form of the embedded webserver and requires the administrator to only “surf” to the imaging device with a browser to access the management facility. The common HTTP interface and protocol also allow a single specific device, class of device, or even device manufacturer to be managed or communicated to either singly or as a group. Imaging device embodiments of the present invention can also act as “interpreters”, translating commands from the administrator received via HTTP with their embedded webservers to a different printer communication protocol that is spoken by other imaging devices on the network. In addition, most network features, such as firewalls or routers, route or will not interfere with HTTP protocol. This allows all of the imaging devices to be communicated with or managed with a minimum of issues, even at remote sites.

Network devices with an embedded web access mechanism for user interface functions including a webserver and a web browser are detailed in U.S. Pat. No. 5,956,487 issued to Venkatraman et al. on Sep. 21, 1999, and in U.S. Pat. No. 6,170,007 issued to Venkatraman et al. on Jan. 2, 2001, both of which are commonly assigned and incorporated herein by reference.

There are several types of HTTP protocol and transport mechanisms. They range from the above mentioned “hypertext transfer protocol” (HTTP) to “hypertext transfer protocol secure” (HTTPS) that utilizes a “secure socket layer” (SSL) encrypting transfer protocol and can be further combined with digital certificates for verification. However, HTTP protocols generally involve transferring encoded text, forms, and graphic documents across networks from a document server (i.e., a webserver) to remote recipients for display and input. HTTP reception and document viewing and interaction is generally done with a program called a “browser.” Generally, HTTP transfers “hypertext markup language” (HTML) for viewing and interaction with a browser.

Many browser programs and appliances exist that enable document viewing on multiple platforms. These platforms range from, but are not limited to, web enabled cell phones, personal digital assistants (PDA), personal computers (PC), Unix workstations, specialized web appliances, web enabled televisions and set-top boxes, to text based terminals with a text rendering web browser. Examples of these programs include, but are not limited to, MICROSOFT INTERNET EXPLORER ™ by Microsoft, Inc. of Redmond, Wash. USA, NETSCAPE NAVIGATOR ™ by Netscape Communication Corporation of Mountain View, Calif. USA, NSCA Mosaic by the National Center for Supercomputing Applications at the University of Illinois at Urbana-Champaign, Ill. USA, and Lynx by the University of Kansas at Lawrence, Kans. USA. In addition, most browsers can be combined with add-in modules that can allow many sub-protocols to be delivered over HTTP providing for display of and input to other formatted documents, forms, and files. Examples of such formatted documents, forms, and files include, but is not limited to, “extensible markup language” (XML), “standard graphic markup language” (SGML), Macromedia Flash, Adobe PDF, and Microsoft Word documents. Browsers also allow for interactive documents and interaction with the end user with such technologies and embedded scripts and programming as Javascript, Visual Basic Script, Flash, and “dynamic hypertext markup language” (DHTML). Browsers and webservers also allow for downloading or uploading of documents and binary files.

As stated above, embodiments of the present invention include imaging devices that have built-in webservers that utilize hypertext transfer protocol (HTTP) to communicate with a coupled network. This allows these imaging devices to be configured and managed over a network with a common non-device-specific interface and protocol, without the need to have a special-purpose device management program or user interface. Embodiments of the present invention also allow for upgrading of the device with a web browser across a network. Additionally, embodiments of the present invention can upgrade or configure some or all of the imaging devices similar to itself on the network. Similar imaging devices, for the purposes of this disclosure, are defined as imaging devices similar with regard to manufacturer, imaging device type, or features. These other imaging devices can be located by manual input of a list of imaging devices, loading a list of other imaging devices from an external source or a “discovery” process that is described infra. These similar devices may also contain embedded webservers themselves or not. This ability therefore allows imaging device embodiments of the present invention to, in effect, become an imaging system management tool for all similar devices to themselves on the network.

When an administrator manages an imaging device embodiment of the present invention, the administrator first “surfs” to the address of the imaging device on the network with a web browser. Once connected to the embedded webserver of the desired imaging device, the administrator can manage it or upgrade its configuration (configuration parameters, firmware, software, or supplemental information) utilizing the embedded webserver without requiring a specialized imaging device management facility. The command interface of the imaging device, that comprises the imaging device's management facility, is generated by the embedded webserver and displayed on the administrator's web browser.

Once at the management facility provided by the imaging device's embedded webserver, the administrator can view, print, or download and save device information, configuration parameters, alerts, usage, statistics, any generated reports, and any generated files utilizing the web browser. Such device information includes, but is not limited to, imaging device address, imaging device default parameters, job origin, number of jobs processed, number of pages imaged, resolution, mode, duplex, economy and performance settings, number of copies of jobs received, number of errors, types of errors, maintenance alerts, marking material (such as toner, ink, transfer material, etc.) usage, marking material level, consumables (such as, paper, transparencies, etc.) type and usage, and other usage information, statistics, or consumables.

At the management facility of the embedded webserver the administrator can also modify device information and configuration parameters by the modification and submission of HTML forms and inputs via the browser to the embedded webserver of the imaging device. Such device information and configuration parameters include, but are not limited to, imaging device address, imaging device default parameters, communication interface parameters, job header and header content, resolution, mode, duplexing, economy settings, and performance settings. Imaging device operation commands can also be given to the imaging device via the embedded webserver management facility. Such commands include, but are not limited to, upgrade configuration parameters, upgrade firmware, upgrade software, upgrade supplemental information, online, offline, restart, reset, purge job, pause job, manage job queue, or another supplemental imaging device command.

Additionally, the configuration parameters can be loaded into the imaging device from a file via the embedded webserver management facility. When loading the configuration parameters, the configuration parameters for convenience can be uploaded to the imaging device directly with the browser. Alternatively, the administrator can use the browser to reference another identical imaging device that is local, or reference a local network site, or a remote network site as the target of the configuration upload operation by the imaging device. For ease of use and to not overwrite desired parameters, a “mask” can be specified to allow for exclusion of selected configuration parameters when uploading parameters in bulk to an imaging device embodiment of the present invention.

The configuration parameters can also be downloaded from the imaging device into a file for backup or later use. When downloading the configuration parameters, the configuration parameters can be downloaded from the device directly with the browser, or alternatively, the administrator can use the browser to reference another identical device that is local, or reference a local network site, or a remote network site as the target of the configuration download operation by the imaging device. For ease of reuse of the downloaded parameters a “mask” can also be specified to allow for exclusion of selected configuration parameters when downloading parameters from an imaging device embodiment of the present invention.

The imaging device firmware or software can also be managed through the embedded webserver of imaging device embodiments of the present invention. The selected imaging device can be instructed by the administrator via the embedded webserver interface to upgrade its firmware or software. When upgrading, the device firmware or software, as with the configuration parameters, can be uploaded to the device directly, can reference another identical device that is on the network, can reference a local network site, or can reference a remote network site as the source of the upgrade file. As an additional feature, the imaging device firmware or software can also be downloaded from the device in case a copy or backup is desired.

If additional storage space is available on the imaging device, such as in a non-volatile memory array or on a hardrive attached to the device, additional files, software, code, or information of interest in managing the imaging device can also be stored. Such information can include, but is not limited to, firmware, software, drivers, code, configuration example files, manuals, and diagnostic programs or management utilities. In this manner, the imaging device embodiment of the present invention with an embedded webserver can act as a repository of information that aids in its own management and administration.

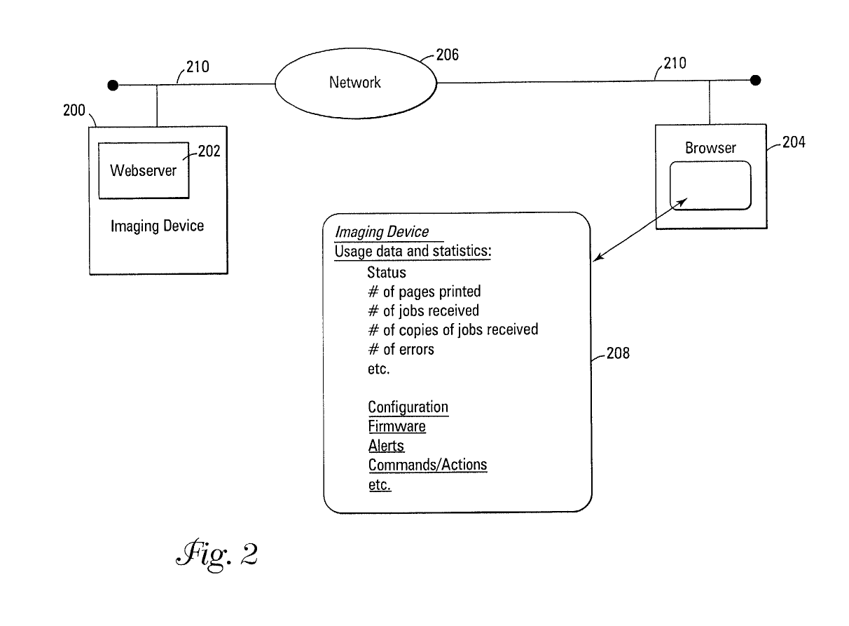

FIG. 2 shows a simplified diagram of an imaging device 200 embodiment of the present invention in communication with a web browser 204 over a network 206. In FIG. 2, the imaging device 200 is shown incorporating an embedded webserver 202 and is coupled to the network 206 by a local network segment 210. The browser 204 is also coupled the network 206 by a local network segment 210 and is shown viewing and changing parameters 208 of the imaging device 200 via the embedded webserver 202.

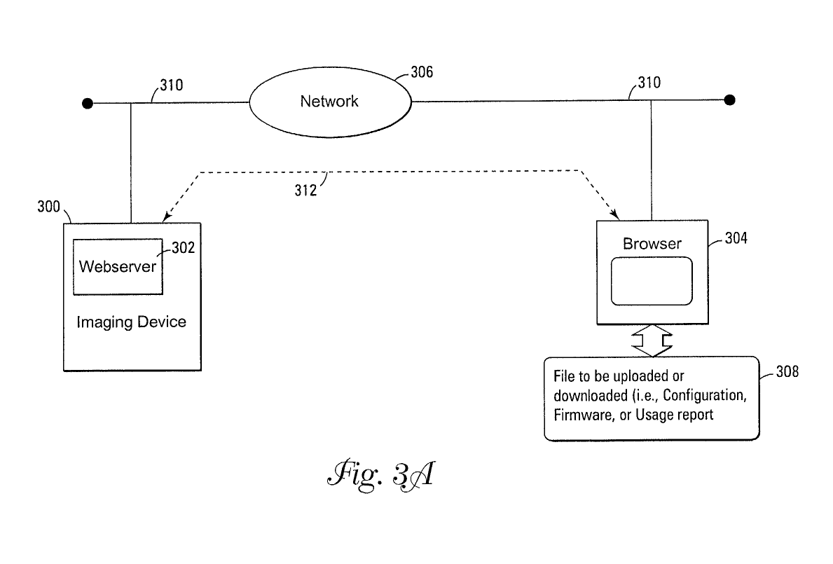

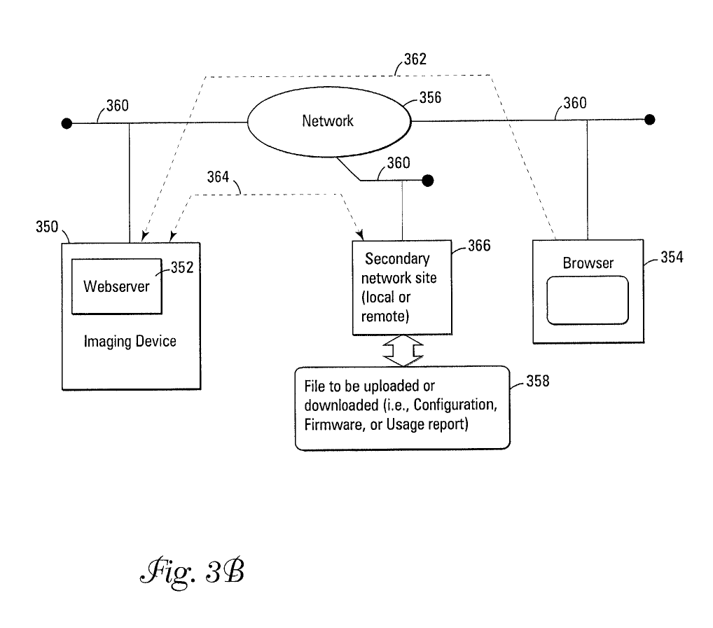

FIG. 3A shows a simplified diagram of an imaging device 300 embodiment of the present invention being communicated to with web browser 304 over a network 306, wherein the web browser 304 is uploading or downloading files 308 over the network 306 to the imaging device 300. In FIG. 3A, the imaging device 300 is shown incorporating an embedded webserver 302 and is coupled to a local network segment 310. The browser 304 is also coupled to a local network segment 310 and is shown uploading or downloading files 308 to the imaging device 300 via the embedded webserver 302. Such files include, but are not limited to configuration parameters, firmware, software, drivers, and documents in text, HTML, Adobe PDF format, Microsoft Word document format, or other document formats.

FIG. 3B shows a simplified diagram of an imaging device 350 embodiment of the present invention being communicated to with web browser 354 over a network 356, wherein the administrator through the web browser 354 directs the imaging device 350 to upload or download files 358 over the network 356 to a secondary network site 366. In FIG. 3B, the imaging device 350 is shown incorporating an embedded webserver 352 and is coupled to a local network segment 360. The browser 354 is also coupled to a local network segment 360 and is shown with the administrator directing 362 the uploading or downloading files 358 to the imaging device 350 with a network reference to a secondary network site 366 via the embedded webserver 352. The secondary network site 366 is shown coupled to a local network segment 360, and can be located on the local network area or on a remote network area. As with the embodiment shown in FIG. 3A, such files include, but are not limited to configuration parameters, firmware, software, drivers, and documents in text, HTML, Adobe PDF format, or Microsoft Word document format.

Imaging device embodiments of the present invention can additionally allow for management of other imaging devices that are similar to itself on the network. After an administrator “surfs” to an imaging device embodiment of the present invention and upgrades or changes the configuration or firmware/software to their satisfaction, the imaging device can be commanded to copy or “clone” all or part of its current configuration to other similar devices on the network. This migrates some or all the changes or upgrades to selected similar imaging devices on the network.

This ability allows for imaging device embodiments of the present invention with embedded webservers to act as a virtual imaging device management system, allowing the administrator to manage the imaging device system without the need of a specialized management program or device. It is noted that this virtual imaging device management system can be utilized from any single web-enabled imaging device embodiment of the present invention on the network. An added advantage is that, as mentioned above, the embedded webserver utilizes HTTP protocol that flows through most network firewalls and network devices that filter network protocols and content. In addition, if HTTP protocol is utilized to upgrade the selected similar imaging devices, it allows for imaging devices outside of these network features to be easily managed and upgraded.

This ability of embodiments of the present invention to clone upgrades and configuration to other devices can also allow for configuration and management of non-web enabled imaging devices. In this situation the imaging device to be upgraded is required to speak a compatible communication protocol, such as printer management language (PML). The imaging device containing the embedded webserver then acts as a translator and allows for the upgrades and configuration changes to proceed as selected by the administrator.

In cloning an imaging device of the present invention to other similar devices, the administrator selects the imaging devices to upgrade from a list of imaging devices present in the imaging device system. This list of imaging devices can either be input from an external source, manually input by the administrator, or “discovered” on the network by the imaging device embodiment of the present invention. The procedures for discovering other imaging devices on a network is well known in the art for many types of devices and communication protocols, and thus will not be covered in this disclosure.

Once entered or discovered, the list of other imaging devices can be maintained internally in the device for future reference. Alternatively the list of other imaging devices can be maintained internally across all embodiments of the present invention, on a network server or device, or on a “master” device that would be tasked with storing references for managing imaging devices in the system. After the list is available, the administrator can select some or all of the listed similar imaging devices to configure and/or upgrade, referred to herein generally as “configure”.

Additionally, the portion of the configuration (such as configuration parameters, mask, firmware/software, or supplemental information) to configure the selected imaging devices with can be selected. As with loading a configuration into a single imaging device with an embedded webserver, a “mask” can be specified if desired to allow for exclusion of selected configuration parameters, allowing the local parameters to be kept. Such local parameters, as described above, can include, but are not limited to, imaging device address, imaging device default parameters, communication interface parameters, job header and header content, resolution, mode, duplexing, economy settings, and performance settings.

After selecting the desired imaging devices and the configuration, the administrator commands the upgrade to take place. The device or devices to be configured then are contacted by the originating device and individually ordered to configure their internal versions of configuration with the configuration provided by the originating device. In effect, the originating imaging device is “pushing” the selected configuration (configuration parameters, masks, firmware/software, or supplemental information) to the imaging devices that were designated.

When loading the configuration (configuration parameters, masks, firmware/software, or supplemental information) into the selected imaging device(s), the configuration can be sent directly to the device(s) being upgraded over the network from the internal memory structures of the originating device. Alternatively, as in the above case of the single device upgrade, the selected imaging device(s) can be directed with an included reference in the command to another network site where the configuration is available. These alternative sites include, but are not limited to, a local network site (such as a computer, a network server, or another similar imaging device), or a remote network site.

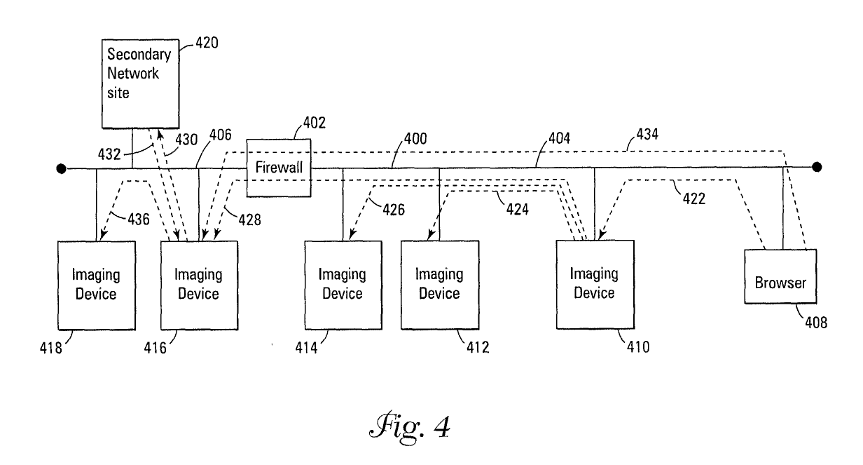

FIG. 4 shows imaging device embodiments of the present invention 410, 412, 414, 416, and 418 being upgraded via direct operations and cloning over a network 400. In FIG. 4, a network 400 is shown with a firewall 402, a local network segment 404, a remote network segment 406, a browser 408, a secondary network site 420, and series of imaging device embodiments of the present invention 410, 412, 414, 416, and 418 that are coupled to the local network segment 404 and the remote network segment 406. In FIG. 4, the administrator utilizing the browser 408 surfs 422 to the embedded webserver (not shown) of imaging device 410 and upgrades or configures it as detailed above. Once satisfied with configuration of the imaging device 410, the administrator commands the imaging device 410 to find other devices like itself, or enters a list of other devices. The administrator then selects the other imaging devices 412, 414, and 416 to be upgraded and the configuration to be cloned to them. The administrator then commands the originating imaging device 410 to upgrade the selected imaging devices 412, 414, and 416 as instructed. The originating imaging device 410 then contacts 424, 426, and 428 the selected imaging devices 412, 414, and 416, and instructs them to upgrade themselves. The originating imaging device 410 then pushes the selected upgrades to imaging devices 412 and 414. Imaging device 416, however, is instructed by the administrator through the originating imaging device 410 to contact 430 a secondary network site 420 and retrieve 432 its upgrade. It is noted that imaging device 416 is on the remote network segment 406, behind a firewall 402 from the originating imaging device 410 that would block most protocols, and thus can be most easily communicated to and upgraded via HTTP from the originating imaging device 410. This upgrading of imaging device 416 can happen either by uploading the configuration to it via HTTP or by referencing a secondary network site 420 for it to get the upgrade from. It is also noted that the procedure of contacting 430 and retrieving 432 the upgrade or configuration from a secondary network site 420 can also be applied to imaging devices 412 and 414 on the local network segment to the originating imaging device 410 if desired. The secondary network site 420 for both types of referenced upgrades can either be local or remote, as with the above single device upgrade.

Alternatively, as stated above, the imaging device 416 embodiment of the present invention, on the remote network segment 406, can be managed and upgraded directly 434 by the administrator from the browser 408 on the local network segment through the firewall 402 by surfing to it via HTTP. Once satisfied with the configuration of the remote imaging device 416, the administrator can command it to find other imaging devices 418 similar to it locally on the remote network segment 406. The remote imaging device 416 can then be commanded to upgrade 436 some or all of these other similar imaging devices 418. This is particularly advantageous when the other similar imaging devices 418 do not contain an embedded webserver. The remote imaging device 416 embodiment of the present invention, which contains an embedded webserver (not shown), can act as a translator for any other similar imaging devices on the remote network segment 406, translating the commands and upgrades to a compatible printer protocol, such as printer management language (PML), that would not otherwise pass through the firewall 402. This ability allows the remote imaging devices 418 and 416 to be managed remotely by the administrator without the need for specialized management programs or network access.

It is noted that alternative manners of upgrading configuration (configuration parameters, masks, firmware/software, or supplemental information) and cloning these configuration parameters and code to other similar imaging devices on the network by embodiments of the present invention are possible and should be apparent to those skilled in the art with the benefit of the present disclosure.

### CONCLUSION

An improved class of imaging devices with an ability to communicate, accept commands, change configuration parameters, view and save status and usage data, store help documents, and upgrade firmware/software via an embedded webserver have been described. The improved imaging devices with an embedded webserver, allow the imaging devices to be managed from a web browser via hypertext transfer protocol (HTTP). This presents an available simple interface and protocol that has the added benefit of being available in most network environments that is also generally routed over firewalls, routers, bridges, and VPNs.

Additionally, the improved imaging devices are adapted to find and/or upgrade similar devices to themselves. The upgrade can transfer the configuration parameters or upgrade files directly from the originating device to the targeted device(s) or simply include a reference to a local or remote secondary network site that contains the configuration or upgrade. Thus the improved imaging devices enable a virtual imaging device management system that can manage a network of other imaging devices.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. An imaging device, comprising:
a processor adapted for communication with a network using an embedded webserver; and
a computer-usable media coupled to the processor;
wherein the processor is adapted to store a configuration on the computer-usable media;
wherein the processor is adapted to store a list of other imaging devices on the computer-usable media; and
wherein the processor is adapted to transmit the configuration through the embedded webserver addressed to at least one of the other imaging devices of the stored list.

2. The imaging device of claim 1, wherein the processor is further adapted to discover the list of other imaging devices.

3. The imaging device of claim 2, wherein discovering the list of other imaging devices further comprises discovering other imaging devices that are similar to the imaging device.

4. The imaging device of claim 1, wherein the embedded webserver is a function of the processor in response to computer-readable instructions stored on the computer-usable media.

5. The imaging device of claim 1, wherein the embedded webserver is adapted to process an upload of configuration selected from the group consisting of configuration parameters, configuration parameters with a mask, firmware, software, supplemental information, configuration parameters from a network site, configuration parameters with a mask from a network site, firmware from a network site, software from a network site, and supplemental information from a network site.

6. The imaging device of claim 1, wherein the embedded webserver is adapted to download information selected from the group consisting of configuration parameters, configuration parameters with a mask, firmware, software, supplemental information, configuration parameters from a network site, configuration parameters with a mask from a network site, firmware from a network site, software from a network site, and supplemental information from a network site.

7. The imaging device of claim 1, wherein the embedded webserver is adapted to process an imaging device command selected from the group consisting of upgrade configuration parameters, upgrade firmware, upgrade software, upgrade supplemental information, online, offline, restart, reset, purge job, pause job, and manage job queue.

8. The imaging device of claim 1, wherein the configuration for transmission to at least one of the other imaging devices is sourced from an originating network device that is selected from the group consisting of the imaging device, a local network site, a remote network site.

9. The imaging device of claim 1, wherein the configuration for transmission to at least one of the other imaging devices is selected from the group consisting of configuration parameters, configuration parameters with a mask, firmware, software, and supplemental information.

10. The imaging device of claim 1, wherein the configuration for transmission to at least one of the other imaging devices is sent via a protocol that is selected from the group consisting of hypertext transport protocol (HTTP), hypertext transport protocol secure (HTTPS) protocol, printer markup language (PML), and a compatible imaging device communication protocol.

11. A method of configuring a plurality of imaging devices coupled to a network, the method comprising:
communicating a configuration change to an embedded webserver of a first imaging device;
communicating the configuration change from the first imaging device to at least one other imaging device from a list of other imaging devices stored on the first imaging device.

12. The method of claim 11, further comprising:
generating the list of other imaging devices; and
storing the list of other imaging devices in the first imaging device.

13. The method of claim 12, wherein generating the list of other imaging devices further comprises discovering a list of other imaging devices similar to the first imaging device.

14. The method of claim 11, further comprising:
translating the configuration change to a printer protocol compatible with an other imaging device prior to communicating the configuration change to that other imaging device.

15. A method of operating a plurality of imaging devices, the method comprising:
communicating a configuration change to an embedded webserver of a first imaging device;
processing the configuration change on the first imaging device, thereby generating a configuration on the first imaging device; and
configuring one or more other imaging devices in response to the configuration change of the first imaging device, wherein the one or more other imaging devices are selected from a list stored on the first imaging device.

16. The method of claim 15, wherein configuring the one or more other imaging devices further comprises communicating the configuration of the first imaging device to the one or more other imaging devices.

17. The method of claim 15, further comprising communicating the configuration change by uploading a baseline configuration selected from the group consisting of configuration parameters, configuration parameters with a mask, firmware, software, supplemental information, configuration parameters from a network site, configuration parameters with a mask from a network site, firmware from a network site, software from a network site, and supplemental information from a network site.

18. The method of claim 15, wherein processing the configuration change further comprises processing a command selected from the group consisting of upgrade configuration parameters, upgrade firmware, upgrade software, upgrade supplemental information, online, offline, restart, reset, purge job, pause job, and manage job queue.

19. The method of claim 15, wherein configuring the one or more other imaging devices further comprises communicating a configuration from an originating network device that is selected from the group consisting of a local network site, and a remote network site.

20. The method of claim 19, wherein a network site is another imaging device.

21. A computer-usable medium having computer readable instructions stored thereon for execution by a processor to perform a method comprising:
processing a configuration change on a first imaging device;
referring to a list of other imaging devices stored in the first imaging device; and
configuring at least one imaging device from the list in response to the configuration change of the first imaging device.

22. The method of claim 21, further comprising configuring at least one imaging device from the list using a configuration of the first imaging device.
